(19) United States
(12) Patent Application Publication
(10) Pub. No.: US 2025/0363536 A1
(43) Pub. Date: Nov. 27, 2025

(54) Configurator Tool for Automated Design and Engineering

(71) Applicant: Electronic Power Design, Inc., Houston, TX (US)

(72) Inventor: Felix Gonzalez, Katy, TX (US)

(73) Assignee: Electronic Power Design, Inc., Houston, TX (US)

(21) Appl. No.: 19/203,303

(22) Filed: May 9, 2025

Related U.S. Application Data
(60) Provisional application No. 63/647,168, filed on May 14, 2024.

(51) Int. Cl. G06Q 30/0601; G06F 30/20; G06Q 30/0283

(52) U.S. Cl. CPC G06Q 30/0611; G06F 30/20; G06Q 30/0283; G06Q 30/06435

(57) ABSTRACT

A cloud-based configurator system and method for the automated design and engineering of electrical switchboards is disclosed. The system includes a web-based interface and a cloud-hosted configurator engine that accesses a database of pre-engineered copper bus components and current inventory data. The configurator automatically generates, evaluates, and selects optimal copper bus routing solutions between designated points using combinations and permutations of existing parts. The system prioritizes in-stock components to reduce manufacturing lead times and optimize cost-efficiency, while eliminating the need to design custom components for each new order. Additional features include dynamic pricing based on spot market data, CRM integration for pre-populating configuration fields, mobile compatibility, generation of AutoCAD-compatible technical drawings, and multi-vendor switchboard variant generation. An administrative dashboard supports configuration management, user analytics, inventory updates, and approval workflows, enabling faster manufacturing throughput, improved customer responsiveness, and increased profitability.

### CROSS REFERENCE TO RELATED APPLICATION

This patent application is based on U.S. provisional patent application entitled “A Configurator Tool for Automated Design and Engineering” filed on May 14, 2024, and assigned Ser. No. 63/647,168, which is hereby incorporated by reference in its entirety.

### BACKGROUND OF THE INVENTION

Manufacturing is slowed by the need to make new parts instead of using parts that are already in stock.

### FIELD OF THE INVENTION

The present invention is related to the field of automated design.

### BRIEF DESCRIPTION OF THE DRAWINGS

FIG. 1 is a depiction of an automated design using parts that are in stock; and

FIG. 2 is a system diagram of a cloud based implementation of a particular illustrative embodiment of the invention.

### SUMMARY OF THE INVENTION

A configurator tool for automated design and engineering using existing stock parts.

### DETAILED DESCRIPTION OF A PARTICULAR ILLUSTRATIVE EMBODIMENT OF THE INVENTION

A detailed description will now be provided. The purpose of this detailed description, which includes the drawings, is to satisfy the statutory requirements of 35 U.S.C. § 112. For example, the detailed description includes a description of inventions defined by the claims and sufficient information that would enable a person having ordinary skill in the art to make and use the inventions. In the figures, like elements are generally indicated by like reference numerals regardless of the view or figure in which the elements appear. The figures are intended to assist with the description and to provide a visual representation of certain aspects of the subject matter described herein. The figures are not all necessarily drawn to scale, nor do they show all the structural details, nor do they limit the scope of the claims.

In a particular illustrative embodiment of the invention, a configurator tool is designed to streamline the process of configuring EPD UL 891 DFS™ switchboard lineups, adhering rigorously to UL 891 standards, with a specific focus on Annex G compliance. Through this RFP, we seek to engage with capable and innovative developers who share our commitment to excellence, efficiency, and client-centric solutions. We are excited to embark on this journey and look forward to collaborating with forward-thinking professionals who can help us achieve our vision for a state-of-the-art CONFIGURATOR tool that will empower our team and enhance our client experience. The configurator tool provides a robust Configure, Price, Quote (CONFIGURATOR) tool, ideally web-based, that will play a pivotal role in enhancing a manufacturer's operational efficiency and customer engagement. While an Excel-based tool will be considered, our preference lies with a web-based solution for its accessibility, scalability, and versatility.

At its heart, this configurator tool is designed to empower our dedicated internal estimating and sales teams by providing them with a robust platform to generate timely and precise quotations. By automating and streamlining the configuration process, a manufacturer's estimators can respond to customer inquiries quickly and with a high degree of accuracy. This not only strengthens our commitment to customer satisfaction but also significantly reduces customer acquisition costs. Moreover, the utility of this configurator tool extends to our valued channel partners. By sharing this configurator tool, we enable a manufacturer's partners to independently configure EPD UL 891 DFS™ switchboard lineups. This empowerment of our channel partners indirectly amplifies the capabilities of our EPD sales team, fostering collaborative growth within our network.

Beyond its role in quoting and sales, this tool holds immense potential for our internal mechanical and electrical engineering designers. It is envisioned as a versatile resource that will streamline and expedite the detailed design phase of our projects, allowing our engineers to work with precision and agility.

In essence, this project signifies a significant step forward for manufacturers in enhancing operational efficiency, empowering manufacturer teams, and facilitating seamless collaboration with manufacturing partners.

The DFS™ switchboard lineup represents a visionary approach to modular and universal design. The configurator tool is not limited to DFS™ switchboards as it can be configured to configure other products, including but not limited to other manufacturers' switchboards and products. This distinctive design approach allows for the integration of circuit breakers from leading manufacturers, including Schneider Electric, ABB, Siemens, and LS Electric. By accommodating multiple manufacturers, EPD not only ensures flexibility but also offers its clients a broader spectrum of choices and compatibility, reinforcing our dedication to customer satisfaction.

One of the standout features of the DFS™ switchboard lineup is its efficient and streamlined construction. In a strategic move to maximize warehousing capacity, optimize fabrication assets, and enhance assembly capabilities, having engineered this product line to consist of fewer components than conventional switchboards. This strategic approach not only serves as a testament to our commitment to efficiency but also presents a competitive advantage for EPD. The reduction in components significantly simplifies the configuration process, aligning perfectly with the objectives of the configurator tool.

Furthermore, the DFS™ switchboards boast modular sheet metal cabinets, providing additional flexibility for customization. These cabinets are available in a range of standard widths, including 24 inches, 30 inches, 36 inches, 42 inches, 48 inches, and 54 inches, catering to various spatial requirements, as shown below in Table 1.

Complementing this, the cabinets are also available in multiple depths, offering flexibility in design and installation. These depths include 24 inches, 36 inches, 48 inches, and 60 inches, ensuring that the DFS™ switchboards can be tailored to meet the precise needs of each project. To facilitate a quick understanding of the twenty-four (24) enclosure size combinations available, see table 1 below. Note that the standard height is always 91.5 inches.

TABLE 1

| Standard Width (inches) | Depth Option (inches) |
|---|---|
| 24 | 24 |
| 24 | 36 |
| 24 | 48 |
| 24 | 60 |
| 30 | 24 |
| 30 | 36 |
| 30 | 48 |
| 30 | 60 |
| 36 | 24 |
| 36 | 36 |
| 36 | 48 |
| 36 | 60 |
| 42 | 24 |
| 42 | 36 |
| 42 | 48 |
| 42 | 60 |
| 48 | 24 |
| 48 | 36 |
| 48 | 48 |
| 48 | 60 |
| 54 | 24 |
| 54 | 36 |
| 54 | 48 |
| 54 | 60 |

Note that the configurator tool will seamlessly and automatically select the appropriate enclosure dimensions based on the various user inputs, ensuring a hassle-free and tailored configuration experience for valued clients.

In summary, the DFS™ switchboard modular design, compatibility with leading manufacturers, reduced component count, and customizable enclosure options make it a distinctive and competitive offering.

In accordance with the UL 891 standards, the allowable bus bar current density, as stipulated in Table 23 of The Standard, is set at 1000 amperes per square inch. To further simplify the subset of allowable bus bar combinations and adhere to these standards, we have opted for standardizing on Copper bus bars while discarding the Aluminum combinations.

This standardization translates to the following allowable ampacities based on different bus bar sizes: 0.25 inches thick×4 inches wide results in an allowable ampacity of 1000 amperes; and 0.25 inches thick×5 inches wide allows for an ampacity of 1250 amperes. These ampacity ratings represent the maximum allowable current carrying capacity per phase as per the UL 891standards. In cases where the required current exceeds these ratings, additional or parallel bus bars come into play to ensure the switchboard's capacity meets the demand.

For instance, if the switchboard necessitates a rating of 2000 amperes, the correct minimum bus size needed would be 0.25 inches thick×4 inches wide×1000 amperes×2 bus bars per phase, resulting in 2000 amperes, as two bus bars in parallel are employed per phase.

To facilitate a better understanding of additional potential ampacity combinations based on these rules and EPD's standard stock bus material, see the following Table 2 and Table 3.

TABLE 2
Allowable Ampacities by Bus Bar Size for 65kAIC-100kAIC
EPD Through Bus Designs - Copper (65K-100KAIC)

| | |
|---|---|
| 1000 | 1-¼″ × 4″ |
| 1200 | 1-¼″ × 5″ |
| 1600 | N/A |
| 2000 | 2-¼″ × 4″ |
| 2500 | 2-¼″ × 5″ |
| 3000 | 3-¼″ × 4″ or 3-¼″ × 5″ for 100% Rated |
| 3200 | N/A |
| 4000 | 4-¼″ × 4″ or 4-¼″ × 5″ for 100% Rated |

TABLE 3
Allowable Ampacities by Bus Bar Size for 42kAIC-50kAIC
Max Ampacity ¼″ × 2¼″ × 3¼″ × 4¼″ × 5¼″ × 6¼″×

| | | | | | | |
|---|---|---|---|---|---|---|
| 200 | 0.40 | 0.27 | 0.20 | 0.16 | 0.13 | 0.11 |
| 400 | 0.80 | 0.53 | 0.40 | 0.32 | 0.27 | 0.23 |
| 800 | 1.60 | 1.07 | 0.80 | 0.64 | 0.53 | 0.46 |
| 1000 | 2.00 | 1.33 | 1.00 | 0.80 | 0.67 | 0.57 |
| 1200 | 2.40 | 1.60 | 1.20 | 0.96 | 0.80 | 0.69 |
| 1250 | 2.50 | 1.67 | 1.25 | 1.00 | 0.83 | 0.71 |
| 1500 | 3.00 | 2.00 | 1.50 | 1.20 | 1.00 | 0.86 |
| 1600 | 3.20 | 2.13 | 1.60 | 1.28 | 1.07 | 0.91 |
| 1750 | 3.50 | 2.33 | 1.75 | 1.40 | 1.17 | 1.00 |
| 2000 | 4.00 | 2.67 | 2.00 | 1.60 | 1.33 | 1.14 |
| 2250 | 4.50 | 3.00 | 2.25 | 1.80 | 1.50 | 1.29 |
| 2500 | 5.00 | 3.33 | 2.50 | 2.00 | 1.67 | 1.43 |
| 3000 | 6.00 | 4.00 | 3.00 | 2.40 | 2.00 | 1.71 |
| 3200 | 6.40 | 4.27 | 3.20 | 2.56 | 2.13 | 1.83 |
| 3500 | 7.00 | 4.67 | 3.50 | 2.80 | 2.33 | 2.00 |
| 3750 | 7.50 | 5.00 | 3.75 | 3.00 | 2.50 | 2.14 |
| 4000 | 8.00 | 5.33 | 4.00 | 3.20 | 2.67 | 2.29 |

Note that 42 kAIC interrupting rating is limited to 200 A-1500 A while 50 kAIC-100 kAIC interrupting rating can accommodate 800 A-4000 A. These standardized ampacity ratings ensure compliance with UL 891 standards and provide a clear framework for configuring EPD UL 891 DFS™ switchboard lineup bus bars.

In adherence to the allowable ampacities and current density as outlined by UL 891 standards, the configurator tool utilizes the following ampacities to meet a wide range of project requirements. These ampacities include: 1000, 1200, 2000, 2500, 3000, and 4000 amperes. It's important to note that bus systems exceeding the 4000 amperes threshold necessitate additional laboratory testing. As such, our focus remains on offering a selection of ampacities within this 4000 amp range which covers 90+% of our project requirements.

Voltage Configuration. Within the DFS™ product line, the manufacture accommodates a range of common voltage configurations to meet various project needs. These configurations are as follows: 3 Phase, 3 Wire Delta Systems; These systems are limited to voltages of 240 volts, 480 volts, 600 volts, and 347 volts; and 3 Phase, 4 Wire Wye Systems: These systems offer voltage configurations including 208/120 volts, 480/277 volts, and 600/347 volts. Note that as of now, for 600 volts, presently manufactured switchboards are limited to 2000A boards, per UL 891 annex G. These voltage configurations represent the most frequently encountered options for our DFS™ product line, providing flexibility and compatibility with a wide range of applications. This information serves as a practical guide for our customers, simplifying the process of choosing the appropriate voltage configuration for their switchboard applications.

Within the switchboard lineup offered by EPD, there are several options for interrupting capacities, each designed to cater to specific safety and operational requirements. The available interrupting capacity options include: 42 kAIC, 50 kAIC, 65 kAIC, 85 kAIC and 100 kAIC. The interrupting capacity is a critical specification that signifies the maximum fault current that the overcurrent protective device can safely interrupt without failure. This specification is vital for ensuring the safe and reliable operation of the switchboard lineup, as it defines the switchboard's ability to handle and control fault currents during unexpected electrical events.

The configurator tool offers two distinct switchboard enclosure ingress protection ratings: Type 1 Rating (Indoor Use): Switchboards with a Type 1 rating are suitable for indoor use. These enclosures provide protection against basic environmental factors while ensuring the safe operation of the switchboard. Type 3R Rating (Outdoor Use): For outdoor applications, EPD offers switchboards with a Type 3R rating. These enclosures are designed to withstand a broader range of environmental conditions, providing enhanced protection against exposure to the elements.

The configurator tool provides universal switchboard design offered by the manufacturer is designed to be fully compatible with circuit breakers from leading manufacturers, including but not limited to: Electronic Power Design; Schneider Electric; ABB; Siemens; and LS Electric. This compatibility ensures that customers have the flexibility to select circuit breakers from these renowned brands, meeting their specific project requirements and preferences. By offering these options, configurator tool provides versatile solutions that align with a range of customer needs and project conditions.

The DFS™ product line offers a range of section types, each tailored to specific functions and requirements within power distribution setups. These section types include:
1. Control Section: This section houses control and monitoring components, facilitating the efficient operation and management of the switchboard.
2. Bus Pull Section: The bus pull section is designed for the convenient and secure connection of incoming power cable to the bus bars, ensuring a reliable power distribution system.
3. Non-Bussed Pull Section: Similar to the bus pull section, this component allows for secure connection from the incoming power cable over to the main adjacent section bus, but without the bussed configuration.
4. Transition Section: Transition sections facilitate the seamless transition of power within the switchboard from top to bottom through-bus or vice versa, ensuring efficient distribution.
5. Utility Metering: This section is dedicated to utility metering, enabling precise monitoring and measurement of power consumption.
6. Customer Metering: For customer-specific metering needs, the customer metering section provides a dedicated space.
7. Main Power Incoming Section: This crucial section serves as the point of entry for the primary power source into the switchboard.
8. Single Power Breaker Feeder Section: Designed to accommodate single power breaker feeders.
9. Two Stacked Power Breaker Feeder Section: For installations requiring multiple power breaker feeders, the two stacked power breaker feeder section offers a space-efficient solution.
10. Distribution Section: The distribution sections can be categorized into two distinct types:
   a. Integral Bus Design: Integral bus design, available from Schneider Electric (i-Line) and ABB (Bus stack), allows distribution breakers to be group-mounted using a line-side connector adapter. This design streamlines installation, reducing labor time.
   b. Bus Strap Kits: The more conventional distribution method, achieved with bus strap kits, involves bus connectors that attach circuit breakers to the distribution bus. While this approach is more labor-intensive to install, it offers cost-effectiveness and shorter lead times.

The main disconnect device, a critical component within the DFS™ product line, can be selected based on specific project requirements. EPD provides the following options:
1. Molded Case Circuit Breaker (Thermal Magnetic or Solid State): These circuit breakers offer reliable protection with options for thermal magnetic or solid-state operation.
2. Power/Insulated Case Circuit Breaker: The power/insulated case circuit breaker is a versatile option suitable for various applications.
3. Fusible Switch: Fusible switches provide an additional level of protection and can be tailored to project needs.
4. Bolted Pressure Switch: Bolted pressure switches offer robust performance and reliable disconnection capabilities.

This range of section types and main disconnect device options ensures that EPD's DFS™ product line can be configured to meet the unique demands of various projects while maintaining the highest standards of performance and reliability.

Electrical utility companies in the industry typically fall into two distinct categories: those affiliated with EUSERC (Electricity Utility Service Equipment Requirements Committee) membership and those operating independently as non-EUSERC entities. EUSERC, standing for ‘Electricity Utility Service Equipment Requirements Committee,’ is a non-profit organization that formulates and upholds industry-specific standards for the design and installation of electrical service equipment, primarily serving the western United States. Our EPD DFS switchboard utility sections are designed to meet the unique demands of utilities, ensuring safety and compliance. The table below provides a list of utility names alongside their corresponding sensing sequences, whether ‘Hot’ or ‘Cold,’ indicative of specific utility preferences.

In a particular illustrative embodiment of the configurator tool, users have the option to specify whether a utility section is required for their configuration. If ‘yes,’ users can then proceed to choose between ‘EUSERC’ or ‘non-EUSERC’ utility options from a dropdown menu. Subsequently, they can select the specific utility name from a provided dropdown list, tailoring the configuration to meet their precise utility needs, as shown in Table 4.

TABLE 4

| | ED&C | | | | |
|---|---|---|---|---|---|
| | Utility | 480 V | | 240 V | |
| Electric [symbol] | Code | [symbol] | Cold | [symbol] | Cold |
| Alameda Bureau of [symbol] | EUSERC | X | | X | |
| Anaheim Public UtilitiesDepartment | EUSERC | X | | X | |
| Anderson [symbol] , IN | AM | X | | X | |
| Anoka Electric Co., MN | AN | X | | X | |
| [symbol] Power Co., VA (NEMA) | AP | X | | X | |
| Arizona Public Service [symbol] | EUSERC | X | | X | |
| Atlantic Electric, NJ | AE | X | | X | |
| Austin [symbol] Deal., TX | [symbol] | X | | X | |
| Azusa [symbol] andWater Department | EUSERC | X | | X | |
| Baltimore Gas & [symbol] , MD | BG | X | | X | |
| Bangor [symbol] Co., ME | BH | | X | X | |
| [symbol] Electric [symbol] | EUSERC | X | | X | |
| Belmont Municipal, MA | BM | | X | | X |
| [symbol] County Public Utility [symbol] No. 1 | EUSERC | X | | X | |
| [symbol] Rural Electric Association | EUSERC | X | | X | |
| Blackstone Valley Elect. Co., RI | BV | X | | X | |
| Boston [symbol] Co. MA | BE | | X | | X |
| Braintree Elect. [symbol] Co., MA | BL | | X | | X |
| Burbank Public ServiceDepartment | EUSERC | X | | X | |
| Burlington Elect., Lighting Dept. VT | BD | X | | X | |
| callum County Public Utility [symbol] | CP | X | | | |
| cambridge Electric Co., MA | CA | | | | X |
| Central Cola [symbol] adoPwr./ [symbol] Com., CD | [symbol] | X | | X | |
| Central Hudson Gas & [symbol] , NY | CH | X | | | |
| Central Illinois LightCo., IL | CT | | | X | |
| Central Illinois Public Service. IL | CV | X | | % | |
| Central Maine Power Co., ME | CM | X | | % | |
| Central Vermont Public Service [symbol] , VT | CR | | X | | X |
| ChelanCounty Public Utility District | EUSERC | X | | X | |
| [symbol] & [symbol] , MA | CL | | X | | X |
| Cincinnati Gas & Electric, OH | CG | X | | | |
| Citizens Utility Company [symbol] Electric [symbol] | EUSERC | | | XX | |
| Clark [symbol] District | EUSERC | X | | | |
| Cleveland Electric [symbol] Co., OH | CC | | | | X |
| Colorado Springs | | X | | X | |
| Colorado [symbol] of Utilities, CD | EUSERC | X | | X | |
| Columbus Div. of Electric, OH | CY | | X | | X |
| Columbus Southern Power, OH | CU | | X | | X |
| Commonwealth Edison Co., IL | CE | X | | | X |
| Commonwealth Electric, MA | CW | X | | | X |
| Concord Electric Co., NH | CO | | X | | X |
| Connecticut [symbol] & Power Co., CT | CN | | X | | X |
| Consolidated Edison Co., NY (298-377) | CS | X | | X | |
| Consumers Power of [symbol] , MI | CF | | X | | X |
| [symbol] Electric Cooperative | EUSERC | X | | X | |
| CP National Corporation | EUSERC | X | | X | |
| [symbol] Electric Co-op., IL | CB | X | | X | |
| [symbol] Elect. Div., MA | DC | | X | | X |
| Dayton Power & LightCo., OH | DP | X | | X | |
| Delaware Power & [symbol] , DE | DL | X | | X | |
| [symbol] Power & Light, DE | DM | X | | X | |
| Des Moines District | | X | | X | |
| Detroit Edison Co., MI | DE | X | | X | |
| Dover, DE | CD | X | | X | |
| [symbol] Co., PA | DU | X | | X | |
| East [symbol] Electric, MN | EC | X | | X | |
| Eastern Edison Co., MA | EE | X | | X | |
| [symbol] and Electric Board | | X | | X | |
| [symbol] Hampton Electric Co., NH | EH | X | | X | |
| Florida [symbol] and Light (NEMA) | | X | | X | |
| FranklinCounty Public Utility District | EUSERC | X | | X | |
| Freeport Electric Dept., NY | FE | X | | X | |
| [symbol] Co., GA (NEMA) | GP | X | | X | |
| [symbol] Public Service Department | EUSERC | X | | X | |
| Granite State, NH (NEMA) | GS | | X | X | |
| Grant County Public Utilities District | EUSERC | X | | X | |
| Gray's [symbol] County [symbol] No. 1 | EUSERC | X | | X | |
| Green Mountain [symbol] Co., VT (NEMA) | GM | | X | X | |
| Green port Electric Dept, NY | GL | X | | X | |
| Gulf State Utilities Co., TX | GE | X | | X | |
| Hampton [symbol] and [symbol] (NEMA) | | | X | X | |
| [symbol] Rural Electric Corp., IA | HC | X | | X | |
| Hawaii Electric Company | EUSERC | X | | X | |
| Hawaii Electric [symbol] Company | EUSERC | X | | X | |
| Heraldsburg Electric | EUSERC | X | | X | |
| Idaho [symbol] | EUSERC | X | | X | |
| Idaho [symbol] Company | EUSERC | X | | X | |
| IllinoisPower CO., IL | [symbol] | X | | X | |
| [symbol] District | EUSERC | X | | X | |
| Indiana [symbol] Michigan Electric Co., IN | IM | X | | X | |
| Indianapolis Power Co., IA | IP | X | | X | |
| Interstate Power Co., IA | IN | | X | | X |
| Iowa Illinois Gas [symbol] Electric, IA | IL | | X | | X |
| Iowa Public service, IA | IS | | X | | X |
| Iowa [symbol] , IA | IU | | X | | X |
| Jacksonville Electric Authority, FL (NEMA) | JE | X | | X | |
| Jersey Central Power [symbol] , NJ | [symbol] | | X | | X |
| Kansas City [symbol] Co., MO | KC | X | | X | |
| Kansas Gas [symbol] Electric Co., KS | KG | X | | X | |
| Kansas Power &Light, KS (NEMA) | KL | X | | X | |
| Kentucky [symbol] , KY (NEMA) | KP | X | | X | |
| Kentucky [symbol] , KY (NEMA) | KU | X | | X | |
| [symbol] Public Utility District | EUSERC | X | | X | |
| Lake [symbol] District [symbol] Co., MN | LS | X | | X | |
| [symbol] District | EUSERC | X | | X | |
| [symbol] Municipal Electric Plant, OK | LM | X | | X | |
| Lincoln Electric System, NE | LC | X | | X | |
| Lodi | EUSERC | X | | X | |
| Lompoc | EUSERC | X | | X | |
| Long Island Lighting Co., NY | LI | X | | X | |
| Los Angeles [symbol] of Water and [symbol] | EUSERC | X | | X | |
| Louisville Gas & Electric Co., KY | LG | X | | X | |
| [symbol] water g.Electric District, ME | LL | | X | | X |
| Madison Gas g.Electric Co., WI | MG | X | | X | |
| [symbol] Public service Co., ME | MP | | X | | X |
| [symbol] Public Utility District | EUSERC | X | | X | |
| Massachusetts Electric Co., MA (NEMA) | MC | X | X | X | X |
| Maul ElectricCompany | EUSERC | X | | X | |
| [symbol] Water and Light | EUSERC | X | | X | |
| [symbol] Electric | EUSERC | X | | X | |
| Riverside Public Utility | EUSERC | X | | X | |
| Rochester Gas& [symbol] Co., NY | RG | X | | X | |
| Rockland Electric | | X | | X | |
| Rockville Centre ElectricDept., NY | RE | X | | X | |
| [symbol] | EUSERC | X | | X | |
| Sacramento [symbol] Utility District | EUSERC | X | | X | |
| Salem [symbol] | EUSERC | X | | X | |
| [symbol] | EUSERC | X | | X | |
| SanDiego Gasand Electric | EUSERC | X | | X | |
| Santa Clara Electric Department | EUSERC | X | | X | |
| Seattle Washington | EUSERC | X | | X | |
| Sierra Pacific Powe, [symbol] | EUSERC | X | | X | |
| [symbol] Public Utility District No. 1 | EUSERC | X | | X | |
| Southern California EdisonCompany | EUSERc | X | | X | |
| Southern California Water [symbol] | EUSERC | X | | X | |
| South Central [symbol] Association, MN | SC | X | | X | |
| South Hadley [symbol] ., MA | SH | | X | | X |
| South Norwalk [symbol] ., CT | SN | | X | | X |
| Southern Indiana Gas & Electric, IN | SI | | X | | X |
| Southern Maryland Co-Op, MD | SM | X | | X | |
| SpringField Utility Board | EUSERC | X | | X | |
| St. Louis [symbol] Electric MI | SL | X | | X | |
| [symbol] Valley Electric [symbol] | EUSERC | X | | X | |
| [symbol] Water [symbol] ., MN | SW | X | | X | |
| Tacoma | EUSERC | X | | X | |
| TallahasseeElectric (NEMA) | | X | | X | |
| [symbol] | EUSERC | X | | X | |
| [symbol] Donne, Public Utility District | EUSERC | X | | X | |
| Tucson [symbol] | EUSERC | X | | X | |
| [symbol] District | EUSERC | X | | X | |
| Toledo Edison, OH | TE | | X | | X |
| Ukia | EUSERC | X | | X | |
| Union [symbol] St. Louis, MO | UE | X | | X | |
| Union [symbol] Heat & Powe, Co., KY | UL | X | | X | |
| United Illuminatine Co., CT | UI | | X | | X |
| Utah Power and [symbol] | EUSERC | X | | X | |
| [symbol] Public Service, VT | VP | X | | X | |
| Vernon water & [symbol] | EUSERC | X | | X | |
| [symbol] of Hamilton, [symbol] | VH | | X | | X |
| Vineland, NJ | CI | | X | | X |
| Virginia [symbol] , Co., VA | VE | X | | X | |
| Wakefield [symbol] , MA | WM | | X | | X |
| Washing Water and [symbol] | EUSERC | X | | X | |
| Watertown [symbol] | WA | | X | | X |
| Watertown [symbol] Utilities, SO | WU | X | | X | |
| [symbol] of Public:Works, MA | WV | | X | | X |
| [symbol] | | | X | | X |
| West Penn [symbol] Co., PA | WP | X | | X | |
| Western Area [symbol] , Administration | EUSERC | X | | X | |
| Western GasandElectric. | | | X | | X |
| Western Massachussetts [symbol] Co., MA | WT | | X | | X |
| Westerville [symbol] Co., OH | WR | X | | X | |
| [symbol] Electric Co-Op., KS | OC | X | | X | |
| Wisconsin Electric [symbol] Co., WI | WE | X | | X | |
| Wisconsin [symbol] & Light Co., WI | WL | X | | X | |
| Wisconsin Public Service, WI | WS | X | | X | |

[symbol]

indicates data missing or illegible when filed

The configuration tool provides users the ability to specify whether the switchboard they are configuring requires seismic qualification. The available options for seismic qualification include:
1. None: This option indicates that no seismic qualification is needed for the switchboard.
2. Importance Factor 1.0: Selecting this option signifies that the switchboard model will undergo analysis, and a certificate will be made available to confirm its compliance with seismic requirements.
3. Importance Factor 1.5: If this option is chosen, it implies that the switchboard will be installed in a critical facility where it must continue to function correctly after a seismic event. In such cases, the specific switchboard model may require a shaker table test if it hasn't been previously tested within the EPD product line matrix. A certificate will be generated to validate compliance with this higher standard.

It's important to note that pricing and lead times are subject to increases based on the chosen seismic qualification level.

Users will have the flexibility to select the entry and exit locations of cable/bus duct for their switchboard. For instance, choosing a ‘bottom entry’ and ‘top exit’ configuration will result in a shallower switchboard design. Conversely, if the entry and exit locations are specified on the same plane (top/top or bottom/bottom), the switchboard will naturally have an increased depth to accommodate the cable entering and exiting the cabinet in close proximity.

These options allow users to tailor their switchboard configurations to align with their project's spatial requirements and layout.

The configurator tool generates a submittal package, which includes the following elements:
1. Quote Document: The tool generates a detailed quote document that provides a description of the configured switchboard lineup. This document includes essential information about the switchboard's specifications, features, lead time, and pricing. Users can choose to receive the quote document in both Word and PDF formats for their convenience.
2. Preliminary Drawings: The CONFIGURATOR tool automatically generates a set of preliminary drawings, offering visual representations of the configured switchboard from various angles, including front, side, top, and bottom views. These drawings also clearly indicate the allocated space for cable conduit ingress and egress. Furthermore, they provide an overall description of the switchboard lineup and include a detailed table listing major power components and their corresponding standard cable lug sizes, power meters, SPDs, and other relevant information.
3. Bill of Material: Users have the option to generate an optional bill of material (BOM) that itemizes the required components and materials for the configured switchboard lineup. The BOM serves as a valuable reference for procurement and assembly, simplifying the purchasing process.
4. Marketing Collateral: For users opting for a full submittal package, the CONFIGURATOR tool includes marketing collateral with images and other general drawings or spec sheets as part of the package.

The configuration tool is designed to integrate with the Global Shop Solutions ERP system, facilitating a streamlined and efficient workflow. While the exact interface details are still being developed, the potential integration offers numerous benefits:

1. Order Entry Integration: With this integration, the process of order entry initiated from Salesforce configurator will seamlessly flow into the Global Shop Solutions ERP system as a sales order. This ensures a smooth transition from the configuration and pricing stage to the order management and fulfillment phase, reducing data entry redundancies and enhancing accuracy.
2. Pricing Information: The configurator tool can leverage pricing information from the ERP system, particularly for parts that already exist within the ERP database. This integration ensures that pricing remains consistent across the organization and eliminates the need for manual price updates, saving time and reducing errors.
3. Lead Time Estimations: Lead time estimations can be significantly enhanced through integration with the ERP system. The configurator tool can factor in existing backlog and the availability of resources or employees within the ERP system to provide more accurate lead time estimations. This dynamic approach to lead time calculations ensures that customers receive realistic delivery estimates based on the current operational capacity. The configurator tool provides a seamless experience that optimizes their workflow and enhances decision-making.

The configurator tool provides engineering advantages.

1. Workload-Based Resource Scheduling: The configurator tool can be extended to assist in scheduling design engineering resources based on workload. By integrating with project management systems, it can help identify available engineering capacity and allocate resources efficiently. This ensures that engineering teams are optimally utilized and projects are completed on time.
2. Critical Material Request Form: The configurator tool provides a critical material request form that includes all long lead items required for a project. Engineering teams can review and identify essential materials upfront. Once reviewed and approved by engineering, the form can be automatically submitted to the purchasing department for timely procurement. This streamlines the process, reducing delays caused by material shortages.
3. Sub-Assembly Drawing Library: To expedite the detailed design process, the configurator tool can incorporate a library of sub-assembly drawings. Engineers can access these pre-designed sub-assemblies as starting points for their own designs, saving time and ensuring consistency in design practices. This library can grow over time as new sub-assemblies are created and validated.
4. Upcoming Raw Material Usage Visibility: The configurator tool can provide early visibility to engineering and purchasing teams regarding raw material requirements, especially for critical materials like copper and sheet metal. It can calculate the quantities needed for each project and provide alerts when material levels are approaching critical levels. This proactive approach ensures that raw materials are secured in a timely manner, preventing production delays.
5. Engineering Collaboration: The tool can facilitate collaboration among engineering teams by providing a centralized platform for sharing design specifications, progress updates, and feedback. This promotes efficient communication and knowledge sharing, leading to improved design quality and faster project completion.

These capabilities extend the utility of the configurator tool beyond configuration and quoting, empowering engineering teams to work more efficiently and collaboratively while ensuring timely access to critical materials and resources. The exact extent of the engineering use case can be explored and tailored to meet the specific needs of your organization.

The user interface (UI) and user experience (UX) of the configurator tool should be thoughtfully designed to provide a pleasant and aesthetic experience for users. Our primary goal is to ensure that the tool is both simple and speedy, promoting user adoption.

The design philosophy behind the tool is to eliminate guesswork and instill confidence in users that they have successfully configured their switchboard lineup. We understand the importance of a user-friendly interface that guides users through the configuration process effortlessly, while the overall aesthetics of the tool enhance the user's experience. The reporting and output capabilities of the configurator tool are designed to offer users maximum flexibility by providing various format options for different reports and outputs

For instance, when generating quotes, users have the choice of two formats: Word Format: This option allows users to receive the quote in Word format, enabling them to make modifications, insert their logos, and tailor the document to their specific requirements. PDF Format: Alternatively, users can opt for the PDF format, which is ideal for those who prefer to receive a finalized, non-editable version of the quote.

The configurator tool offer two primary drawing formats: DWG Format: Drawings are generated in DWG format, which provides users with the flexibility to further modify the drawing to suit their preferences. This format is ideal for users who require customizable drawings to meet specific project requirements. PDF Format: In addition to DWG, we also provide drawings in PDF format. This format is non-editable and serves as a finalized, easily shareable version of the drawing.

The configurator tool is designed with user authentication and access control measures in place. Our primary focus is to ensure that access to the tool is restricted to a select group of B2B channel partners and authorized users.

Invitation-Only Access: Access to the configurator tool is granted through invitation. This means that users will receive invitations from the authorized administrator(s) or designated personnel within their organizations. This invitation-only approach ensures that access is extended to individuals and entities with legitimate business relationships. User Authentication: To guarantee the security of the tool, user authentication is mandatory for each login. This authentication process verifies the identity of users and safeguards against unauthorized access.

In a particular illustrative embodiment of the invention, a cloud based Configurator Tool for Automated Design and Engineering Tool is provided (hereinafter “Configurator Tool”). In the past, a manufacturer had to use a library of existing parts that have already been previously engineered and designed, and another library of existing parts that are in stock to configure and design a copper bus circuit routing within a switchboard.

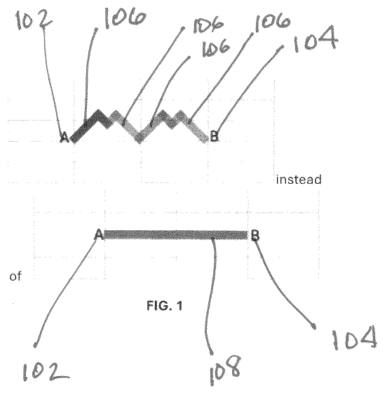

For example, in an illustrative embodiment of the invention, as shown in FIG. 1, A manufacturer needs to build a copper bus connection from Point A 102 to B 104, but we only has one “L” Shaped design of a copper bus 106 part number in stock and has a quantity of four each of these part 106 numbers in stock. This potentially less “expensive” and way more profitable for us to use these four copper bus parts 106 in stock consisting of this one copper bus part number instead of making a “new” part number with a straight piece of copper bus 108 to get from a starting point A to and end point B. For example, this may enable the manufacturer to ship a switchboard in 2 weeks with parts in stock instead of 20 weeks because there is a 20 week delivery time for this size of copper bus, and the manufacturer is out of raw material to make a copper bus bar. A manufacturer may be able to charge more to get this switchboard out more quickly using the parts 106 that are in stock.

In a particular illustrative embodiment of the invention, a software module that is stored in a non-transitory computer readable medium and executed by a processor, will have instructions stored in the non-transitory computer readable medium to try all combinations and permutations of every piece of bus that the manufacturer has engineered and designed and again for all combinations and permutations of every piece of bus that the manufacturer has in stock to come up with a solution for the desired copper bus routing in the most efficient manner. (In a practical sense, there will only be a few hundred different bus designs so there will only be a relatively small finite number of combinations to try; say 1,000,000 combinations—which should be extremely fast and easy for a computer).

In a particular illustrative embodiment of the invention, a configurator tool, an Automated Design & Engineering Tool provides solutions without redesigning new pieces of bus on an order-for-order basis. This facilitates manufacturing since the manufacturer only fabricates a known quantity of part numbers. This makes the warehouse job improve drastically to inventory these manufactured parts with known shelf spaces and replenishment cycles. All of this makes manufacturing efficient and time saving which in turn increases manufacturing capacity, makes manufacturing volume increase, makes shipping quantity go up, which ultimately makes a manufacturer's sales revenue go up and profits increase, even at the expense of some wasted copper and an increase of cost of goods sold. This also makes engineering faster, which saves time and money.

In a particular illustrative embodiment of the invention, the software analyzes the cost versus savings for each design taking limited resources into account for engineering schedules and labor, fabrication schedules and labor, manufacturing schedules and labor and raw material consumption.

While past configurator facilities are functional, they present several challenges: they are cumbersome (separate tools), generic (lacking customization for a manufacturer's specific offerings) and expose a manufacturer to uncertainty. Developing a bespoke configurator tool for a particular customer or user configurator enables a manufacturer to reduce these risks. In addition, this present invention provides a manufacturer with increased efficiency, improved customer satisfaction, and accelerated sales through features like automated workflows, mobile access, and data-driven insights. Moreover, the present invention provides dynamic pricing and streamlined quoting ensure accurate cost estimates.

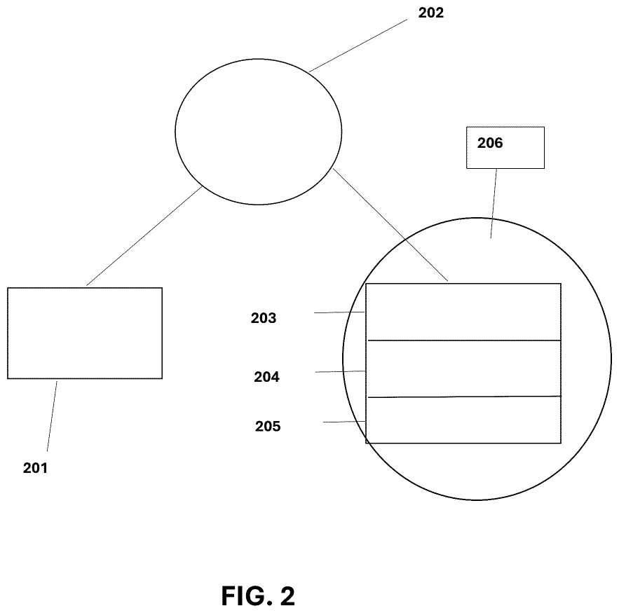

Turning now to FIG. 2, FIG. 2 is a system diagram of a cloud based implementation of a particular illustrative embodiment of the invention. As shown in FIG. 2, user terminal 201 enables a user to connect to a cloud platform 202. The cloud platform enables the user terminal to communicate with a cloud based Configurator Tool for Automated Design and Engineering (referred to herein as EPIC) 206 in a particular illustrative embodiment of the invention. The Configurator Tool for Automated Design and Engineering is connected to cloud 202 and has a database 203, processor and a non-transitory computer readable medium 205.

Thus the configurator tool can select a particular manufacturer and use a library of in stock parts to build a particular product for the particular manufacturer. The configurator tool also estimates a cost for building a particular product from a particular manufacturer.

In a particular illustrative embodiment of the invention, a web application configurator tool is provided with the following key features: EPD Cost Tables For: Siemens products; ABB products; Schneider products; Other future vendors (ex: LS Electric); EPD cabinet sizes, bus sizes, and materials; and other balance of system purchased parts such as lugs, voltage sensing transformers (PTs), current sensing transformers (CTs), control power transformers (CPTs), power supplies, power meters, protection relays, automatic transfer switch controls (ATS), manual transfer key interlocks, surge protective devices (SPD).

In a particular illustrative embodiment of the invention, an example step-by-step configuration flow follows. The present invention provides a standalone and a web application that enables a user to configure the following: The name, location, and delivery date of the switchboard; General switchboard options such as, source type, system ampacity, max available fault current, bus bar material, structure options; add and configure any number of main, incoming, and feeder circuit breakers. Additional parameters can include but are not limited to: auxiliary section (bussed or non-bussed); name of utility (EUSERC member or non-EUSERC utility); incoming nominal voltage (600, 480, 208, etc.); connection type (3 phase/3 wire, 3 phase/4 wire, DC, etc.); bus bar material treatment (tin plating or silver flashed); incoming and outgoing cable location (top/bottom); structure options include (indoor type 1 and outdoor type 3R); current density rated through-bus as defined by UL 891 standard versus IEEE rated bus; and (Additional configuration parameters will be defined).

In a particular illustrative embodiment of the invention, the configurator tool Pre-Populates Data from Salesforce: To minimize data reentry, the present invention will leverage Salesforce data to pre-populate relevant customers and project information for new configuration records. Example fields: name, location, and delivery date. In a particular illustrative embodiment of the invention, the configurator tool provides Business Logic Enforcement: The web application will ensures adherence to business rules and logic throughout the configuration flow; Generates Preliminary Drawings: The drawing allow customers to appraise the proposed design and obtain their feedback; Generates a Quote Documents: The documents will provide a price quote as well as a lead time estimate.

In a particular illustrative embodiment of the invention, the configurator tool provides Salesforce Integration: manufacturer employees s access the Configurator through Salesforce. Additionally, Salesforce login information will be propagated to the Configurator tool of the present invention. In a particular illustrative embodiment of the invention, the configurator tool the configurator web application can be deployed to a cloud platform, such as the Google Cloud Platform. In a particular illustrative embodiment of the invention, the configurator tool is a software program downloaded into a computer readable medium for standalone us without an internet connection. In a particular illustrative embodiment of the invention, the configurator tool Platform Agnostic Architecture, the Configurator tool provides a platform agnostic architecture, giving it the flexibility to be deployed on cloud platforms like Amazon Web Services or Microsoft Azure as well as on-premises environments.

In a particular illustrative embodiment of the invention, the configurator tool provides mobile optimization. The configurator tool will be usable across iPhone, iPad, Android phones, and Android tablets. The configurator tool provides for saved configuration designs: Users will be able to save and update configuration designs within the Configurator web application. In a particular illustrative embodiment of the invention, the configurator tool Shares Configuration Designs. Users share configuration designs with customers or other manufacturer employees through a link with proper authentication and permission. In a particular illustrative embodiment of the invention, the configurator tool provides an administrative Dashboard for Configurator: in the Configurator, an admin interface will be provided with the following features: User Analytics: How many users have logged in; how many configurations have been started; and how many configurations have been completed.

In a particular illustrative embodiment of the invention, the configurator tool provides design Management. A user can view all configurations created using the tool. A user performs Inventory Management: Add inventory parts and update cost data directly within the platform without engineering assistance. In a particular illustrative embodiment of the invention, the configurator tool provides for dynamic pricing. The configurator tool automatically adjusts raw material and component prices through manual overrides or based on spot-price data from 3rd party websites (ex: tradingeconomics.com); In a particular illustrative embodiment of the invention, the configurator tool provides configuration approval workflow: The configurator tool provides a review and approval process for quotes and designs created by non-manufacturer users. Approval from the manufacturer estimator will be needed before the non-manufacture user can download or print a quote.

In a particular illustrative embodiment of the invention, the configurator tool provides automatic variant generation: When a user configures a switchboard, the Configurator will be able to automatically generate configurations for alternative brands (Siemens, ABB, Schneider) based on the user's initial selection. In a particular illustrative embodiment of the invention, the configurator tool provides switchboard configuration: The configurator tool allows users to configure switchboards using components from: Schneider Electric; ABB; Siemens; and other future vendors.

In a particular illustrative embodiment of the invention, the configurator tool provides switchboard variants: A configured switchboard will be able to switch between brands with minimal effort. The configurator tool displays warnings and errors: The Configurator tool will notify the user of violated configuration constraints: sizing constraints; and safety constraints. The Configurator tool will be a user-friendly and intuitive tool for configuration tasks. The configurator tool generates documents. The Configurator will transfer data with Salesforce to enable accurate PDF quote generation. The Configurator will generate technical drawings in an AutoCAD compatible format (ex: DXF or DWG) and PDF format of the configured designs. The output will consist of at least the following: front/top/bottom/side elevations, electrical one line, system description, load list information.

The Configurator tool allows users to save, and update configured designs. The Configurator will allow a user to share configured designs. In a particular illustrative embodiment of the invention, the configurator tool the Configurator is deployed on Google Cloud Platform. The Configurator will allow users to: save configurations for future reference; and update saved configurations. A user shares saved configurations with designated users based on the chosen permission structure. The configurator tool supports a flow in which a manufacturer estimator is notified about a new quote created by a non-manufacturer employee. The estimator will be able to approve that quote before it can be downloaded by the non-employee. The configurator tool generates a cost to manufacture from which an estimate is generated.

In a particular illustrative embodiment of the invention, the configurator tool Salesforce Integration: The Configurator tool is available within Salesforce and meets the following criteria: the configurator tool is visible in the Salesforce app launcher; supports login through Salesforce credentials; and data from Salesforce is used to pre-populate fields in the Configurator. The Configurator provides a secure login system, with options including but not limited to login through Salesforce (minimum requirement); and additional customer login functionalities (to be defined by the Client). The Configurator tool provides an admin interface for managing product pricing updates; adding new components to the database; providing raw material price estimates based on market spot pricing data. Admins can override these calculated values.

The present inventions can be realized in hardware, software, or a combination of hardware and software. In a specific embodiment, a system according to the present inventions can be realized in a centralized fashion in one computer system, or in a distributed fashion where different elements are spread across several interconnected computer systems. Any kind of computer system or other apparatus adapted for carrying out the methods and inventions described herein may be used for purposes of the present inventions. A typical combination of hardware and software could be a general-purpose computer system with a computer program that, when being loaded and executed, controls the computer system such that it carries out the methods and inventions described herein.

The figures herein include block diagram and flowchart illustrations of methods, apparatus(s) and computer program products according to various embodiments of the present inventions. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus may be used to implement the functions specified in the block, blocks or flow charts. The flow chart is an example only and the steps shown in the flow chart need not be executed in the exact order shown on the flow chart. Moreover, some of the steps in the flow chart can be left out in performing the system and method of the present invention. These computer program instructions may also be stored in a computer-readable medium or memory that can direct a computer or other programmable data processing apparatus to function in a particular manner, such that the instructions stored in the computer-readable medium or memory produce an article of manufacture including instructions which may implement the function specified in the block, blocks or flow charts. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block, blocks or flow chart. Those skilled in the art should readily appreciate that programs defining the functions of the present inventions can be delivered to a computer in many forms, including but not limited to: (a) information permanently stored on non-writable storage media (e.g., read only memory devices within a computer such as ROM or CD-ROM disks readable by a computer I/O attachment); (b) information alterably stored on writable storage media (e.g., floppy disks and hard drives); or (c) information conveyed to a computer through communication media for example using wireless, baseband signaling or broadband signaling techniques, including carrier wave signaling techniques, such as over computer or telephone networks via a modem, or via any of the networks known. A diagram is shown illustrating an example of a computer that may be used in connection with the present inventions. The computer may include at least one processor and at least one memory, each of which may be coupled to a local interface or bus. An operating system may be stored in the memory and executable by the processor. Any variety of software programs may also be stored in the memory and executable by the processor. In a specific embodiment, examples of programs that may be stored in the memory and executable by the processor. A media player application may be stored in the memory and executable by the processor. Also stored in the memory may be various forms of data. The term “executable” as used herein means that a program file is of the type that may be run by the processor. In specific embodiments, examples of executable programs may include without limitation: a compiled program that can be translated into machine code in a format that can be loaded into a random access portion of the memory and run by the processor; source code that may be expressed in proper format such as object code that is capable of being loaded into a random access portion of the memory and executed by the processor; or source code that may be interpreted by another executable program to generate instructions in a random access portion of the memory to be executed by the processor. An executable program may be stored in any portion or component of the memory including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components. The memory may include both volatile and nonvolatile memory and data storage components. Volatile components are those that do not retain data values upon loss of power. Nonvolatile components are those that retain data upon a loss of power. Thus, the memory may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random-access memory (SRAM), dynamic random-access memory (DRAM), or magnetic random-access memory (MRAM) and other such devices. The ROM may comprise, for example, a programmable read-only memory (PROM), an erasable programmable read-only memory (EPROM), an electrically erasable programmable read-only memory (EEPROM), or other like memory device. In a specific embodiment, the processor may represent multiple processors and/or multiple processor cores and the memory may represent multiple memories that operate in parallel processing circuits, respectively. In such a case, the local interface may be an appropriate network that facilitates communication between any two of the multiple processors, between any processor and any of the memories, or between any two of the memories. The local interface may comprise additional systems designed to coordinate this communication, including, for example, performing load balancing. The processor may be of electrical or of some other available construction. Although the programs and other various systems, components and functionalities described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components. Such technologies are generally well known by those skilled in the art and, consequently, are not described in detail herein. The flowchart shows the functionality and operation of various specific embodiments of certain aspects of the present inventions. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s). Although the flowchart shows a specific order of execution, it is understood that the order of execution may differ from that which is depicted. For example, the order of execution of two or more blocks may be scrambled relative to the order shown. Also, two or more blocks shown in succession may be executed concurrently or with partial concurrence. Further, in some embodiments, one or more of the blocks shown may be skipped or omitted. In addition, any number of counters, state variables, warning semaphores, or messages might be added to the logical flow described herein, for purposes of enhanced utility, accounting, performance measurement, or providing troubleshooting aids. It is understood that all such variations are within the scope of the present inventions. Any logic or application described herein that comprises software or code can be embodied in any non-transitory computer-readable medium, such as computer-readable medium, for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present inventions, a “computer-readable medium” may include any medium that may contain, store, or maintain the logic or application described herein for use by or in connection with the instruction execution system.

The computer-readable medium may comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random-access memory (RAM) including, for example, static random-access memory (SRAM) and dynamic random-access memory (DRAM), or magnetic random-access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device. The computer may further include a network interface coupled to the bus and in communication with a network. The network interface may be configured to allow data to be exchanged between computer and other devices attached to the network or any other network or between nodes of any computer system or the video system. In addition to the above description of the network, it may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, the network interface may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol. The computer may also include an input/output interface coupled to the bus and also coupled to one or more input/output devices, such as a display, a touchscreen, a mouse or other cursor control device, and/or a keyboard. In certain specific embodiments, further examples of input/output devices may include one or more display terminals, keypads, touchpads, scanning devices, voice or optical recognition devices, or any other devices suitable for entering or accessing data by one or more computers. Multiple input/output devices may be present with respect to a computer or may be distributed on various nodes of computer system, the system and/or any of the viewing or other devices. In some embodiments, similar input/output devices may be separate from the computer and may interact with the computer or one or more nodes of computer system through a wired or wireless connection, such as through the network interface. It is to be understood that the inventions disclosed herein are not limited to the exact details of construction, operation, exact materials or embodiments shown and described. Although specific embodiments of the inventions have been described, various modifications, alterations, alternative constructions, and equivalents are also encompassed within the scope of the inventions. Although the present inventions may have been described using a particular series of steps, it should be apparent to those skilled in the art that the scope of the present inventions is not limited to the described series of steps. The specification and drawings are, accordingly, to be regarded in an illustrative rather than a restrictive sense. It will be evident that additions, subtractions, deletions, and other modifications and changes may be made thereunto without departing from the broader spirit and scope of the inventions as set forth in the claims set forth below. Accordingly, the inventions are therefore to be limited only by the scope of the appended claims. None of the claim language should be interpreted pursuant to 35 U.S.C. 112(f) unless the word “means” is recited in any of the claim language, and then only with respect to any recited “means” limitation.

Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology. Various terms as used herein are defined below, and the definitions should be adopted when construing the claims that include those terms, except to the extent a different meaning is given within the specification or in express representations to the Patent and Trademark Office (PTO). To the extent a term used in a claim is not defined below or in representations to the PTO, it should be given the broadest definition persons having skill in the art have given that term as reflected in at least one printed publication, dictionary, or issued patent.

Certain specific embodiments of methods, structures, elements, and parts are described below, which are by no means an exclusive description of the inventions. Other specific embodiments, including those referenced in the drawings, are encompassed by this application and any patent that is issued therefrom.

1. A Configurator Tool for Automated Design and Engineering of switchboards, comprising:
a user terminal connected to a configurator tool;
a processor and a non-transitory computer readable medium on the configurator tool;
a software module stored on the non-transitory computer readable medium and executed by the processor, the software module comprising instructions to access a library of previously engineered and designed copper bus parts; instructions to access an in stock library of copper bus parts that are in stock; instructions to try all combinations and permutations of copper bus parts from the engineered and designed library to create a copper bus routing from a starting point to an end point in a switchboard; instructions to try all combinations and permutations of copper bus parts from the in stock library to create the copper bus routing; instructions to provide a solution that uses available parts and results in efficient manufacturing and reduced delivery time; and instructions to provide the solution through the user terminal.

2. The Configurator Tool of claim 1, wherein the software module is configured to provide a solution without creating a new part number for copper bus.

3. The Configurator Tool of claim 1, wherein the software module provides a cost and savings for each copper bus routing solution based on engineering schedules and labor, fabrication schedules and labor, manufacturing schedules and labor, and raw material consumption.

4. The Configurator Tool of claim 1, wherein the software module enables the manufacturer to fabricate a known quantity of part numbers on an Order-for-Order basis.

5. The Configurator Tool of claim 1, wherein the software module improves efficiency of manufacturing by allowing warehouse inventory to be organized with known shelf spaces and replenishment cycles.

6. The Configurator Tool of claim 1, wherein the configurator tool is cloud based, wherein the software module enables faster engineering and manufacturing, increasing manufacturing capacity, increasing manufacturing volume, increasing shipping quantity, and increasing sales revenue and profits.

7. A configurator tool for configuring switchboards, comprising instructions to:
receive input related to a name, location, and delivery date of a switchboard;
receive input for general switchboard options including source type, system ampacity, max available fault current, bus bar material, and structure options;
receive input to add and configure any number of main, incoming, and feeder circuit breakers;
receive additional input including auxiliary section type, utility name, incoming voltage, connection type, bus bar material treatment, cable location, structure type, and bus rating.

8. The configurator tool of claim 7, wherein the configurator tool pre-populates data from Salesforce to minimize data reentry.

9. The configurator tool of claim 7, wherein the configurator tool enforces business rules and logic during configuration flow.

10. The configurator tool of claim 7, wherein the configurator tool generates preliminary drawings and quote documents including but not limited to lead time and pricing.

11. The configurator tool of claim 7, wherein the configurator tool integrates with Salesforce and allows login through Salesforce credentials.

12. The configurator tool of claim 7, wherein the configurator tool is deployed to a cloud platform and supports platform agnostic architecture.

13. The configurator tool of claim 7, wherein the configurator tool is optimized for use on iPhone, iPad, Android phones, and Android tablets.

14. The configurator tool of claim 7, wherein the configurator tool is a web based application, wherein the application allows saving, updating, and sharing of configuration designs with authentication and permission.

15. The configurator tool of claim 7, further comprising:
an admin interface comprising user analytics, design management, inventory management with cost data updates and dynamic pricing based on spot-price data or manual overrides.

16. The configurator tool of claim 7, wherein the configurator tool supports a configuration approval workflow requiring manufacturer estimator approval before a quote can be downloaded or printed.

17. The configurator tool of claim 7, wherein the configurator tool automatically generates configurations for alternative brands based on an initial selection.

18. The configurator tool of claim 7, wherein the configurator tool allows configuration of switchboards using components from multiple vendors.

19. The configurator tool of claim 7, wherein the configurator tool generates documents including technical drawings in AutoCAD format and PDF, the drawings including at least front, top, bottom, side elevations, electrical one line, system description, and load list.

20. A non-transitory computer-readable medium storing a computer program comprising instructions that, when executed by one or more processors, cause a computing system to perform a method for configuring and quoting a DFS™ UL 891 switchboard lineup, the computer program comprising:
instructions to receive user input defining a switchboard lineup, including one or more of: a main device section and one or more distribution sections;
instructions to validate the input using a rules engine UL 891 compliance and product constraints;
instructions to generate a validated switchboard configuration based on the input; and
instructions to generate, based on the validated configuration, a bill of materials (BOM); a layout drawing; pricing data; and routing information for use by a manufacturing or ERP system.
